(19) United States
(12) Patent Application Publication
(10) Pub. No.: US 2015/0371257 A1
(43) Pub. Date: Dec. 24, 2015

(54) SYSTEMS AND METHODS FOR PREDICTING RESULTS BASED ON MARKETING DATA

(71) Applicant: CORTEX AUTOMATION INC., Boston, MA (US)

(72) Inventors: Matthew PETERS, Boston, MA (US); Brennan WHITE, Boston, MA (US); Clint FRALICK, Slatersville, RI (US); Dimitry KUDRYAVTSEV, Boston, MA (US)

(73) Assignee: CORTEX AUTOMATION INC., Boston, MA (US)

(21) Appl. No.: 14/744,466

(22) Filed: Jun. 19, 2015

Related U.S. Application Data
(60) Provisional application No. 62/014,298, filed on Jun. 19, 2014.

(51) Int. Cl. G06Q 30/02; G06Q 50/00

(52) U.S. Cl. CPC G06Q 30/0244; G06Q 50/01; G06Q 30/0249

(57) ABSTRACT

Systems and methods for generating an optimized marketing strategy are provided. A user can request analysis of marketing data. The marketing data can be collected from various sources. The collected data can be consolidated and analyzed by an analysis module. An optimal strategy for distribution of future marketing materials can be generated. The strategy can be automatically executed by the system.

### RELATED APPLICATIONS

This application relates to and claims priority under 35 U.S.C. §119(e) to U.S. Provisional Patent Application No. 62/014,298, titled “SYSTEMS AND METHODS FOR PREDICTING RESULTS BASED ON MARKETING DATA,” which was filed on Jun. 19, 2014 and is hereby incorporated by reference herein in its entirety.

### TECHNICAL FIELD

The technical field relates generally to computer-based methods and apparatuses, including computer program products, for predicting results based on marketing data, and in particular to predicting results based on social media data for the purposes of marketing automation in various forms.

### BACKGROUND

Marketers currently face enormous challenges due to the ever-increasing number of platforms and channels that greatly increase the complexity of marketing planning and tactics. Additionally, the modern state of marketing requires such rapid creation and distribution of targeted, unique content that organizations struggle to meet the demand while maintaining quality. These challenges can be seen particularly in social media marketing where marketers are often creating dozens of units of content per day that need to be distributed across a growing list of social networks like Facebook, Twitter, Instagram, and Pinterest.

Currently available tools and software often aim to alleviate the challenges of one or a few platforms at a time, providing point solutions for specific tasks. These tools do not address the complexity of marketing that is created by the launch of new platforms, new forms of content, and new ways for people share information.

In order to successfully execute marketing efforts today and in the future marketers must have assistance. This assistance is most effectively achieved by autonomous computer systems that are able to intelligently automate many elements of the marketing workflow and automatically adjusting to new platforms and channels. Automation produces superior outcomes while requiring less work from marketers and minimizing human error.

### SUMMARY OF THE INVENTION

The techniques disclosed herein aggregate marketing data, such as social media data, from a variety of sources, such as social media networks and execute a series of data analysis algorithms to predict a desired result, such as to predict a result based on a company's request. An example of the result of these algorithms would be the creation of an optimally engaging posting plan for a company on their social profiles, and the automated execution of that plan by a software without direct intervention by the user. Using machine learning and artificial intelligence systems, this plan is then continually refined and improved autonomously by the software without action from the user. Significant portions of a marketer's job can be intelligently automated by a software platform that uses the techniques disclosed herein. This can result in numerous benefits for the organization, including but not limited to: necessitating a smaller marketing team, necessitating fewer tools and software, improving workflow efficiency, and providing significantly improved ROI.

According to some embodiments, a method for optimizing marketing comprises receiving from a user device a request to analyze marketing data associated with a marketer, wherein the received request further includes goals of the analysis, collecting, via a logging module, marketing data associated with the marketer from at least one third party web server, analyzing the marketing data for patterns associated with a desired outcome, generating an optimal strategy for distribution of marketing elements across third party web applications, automatically executing the optimal strategy, wherein the executing includes periodically distributing marketing materials to third party web applications at defined intervals, and sending an indication of the optimal strategy to the user device. The analyzing the marketing data for patterns can further comprise comparing times associated with subsets of the marketing data. The optimal strategy can further include generating an optimal daily distribution time for marketing materials. The third party web applications can include at least one social network. The collected marketing data can include data associated with competitors of the marketer. The received request can further include a budget associated with advertising materials to be used with the generated optimal strategy. The periodically distributing marketing materials can further comprise automatically creating a post on the at least one social network.

According to some embodiments, a system for optimizing marketing strategy comprises one or more processors communicatively coupled to a network, wherein the one or more processors are configured to receive, by a computing device, from a user device a request to analyze marketing data associated with a marketer, wherein the received request further includes goals of the analysis, collect, by a logging module being executed by the computing device, marketing data associated with the marketer from at least one third party web server, analyze, by the computing device, the marketing data for patterns associated with a desired outcome, generate, by the computing device, an optimal strategy for distribution of marketing elements across third party web applications, automatically execute, by the computing device, the optimal strategy, wherein the executing includes periodically distributing marketing materials to third party web applications at defined intervals, and send, by the computing device, an indication of the optimal strategy to the user device. The analyzing the marketing data for patterns can further comprise comparing times associated with subsets of the marketing data. The optimal strategy can further include generating an optimal daily distribution time for marketing materials. The third party web applications can include at least one social network. The collected marketing data can include data associated with competitors of the marketer. The received request can further include a budget associated with advertising materials to be used with the generated optimal strategy. The periodically distributing marketing materials can further comprise automatically creating a post on the at least one social network.

According to some embodiments, an article of manufacture for optimizing marketing strategy can comprise at least one non-transitory processor readable storage medium, and instructions stored on the at least one medium, wherein the instructions are configured to be readable from the at least one medium by at least one processor and thereby cause the at least one processor to operate so as to receive, by a computing device, from a user device a request to analyze marketing data associated with a marketer, wherein the received request further includes goals of the analysis, collect, by a logging module being executed by the computing device, marketing data associated with the marketer from at least one third party web server, analyze, by the computing device, the marketing data for patterns associated with a desired outcome, generate, by the computing device, an optimal strategy for distribution of marketing elements across third party web applications, automatically execute, by the computing device, the optimal strategy, wherein the executing includes periodically distributing marketing materials to third party web applications at defined intervals, and send, by the computing device, an indication of the optimal strategy to the user device. The analyzing the marketing data for patterns can further comprise comparing times associated with subsets of the marketing data. The optimal strategy can further include generating an optimal daily distribution time for marketing materials. The third party web applications can include at least one social network. The collected marketing data can include data associated with competitors of the marketer. The received request can further include a budget associated with advertising materials to be used with the generated optimal strategy.

These and other capabilities of the disclosed subject matter will be more fully understood after a review of the following figures and detailed description. It is to be understood that the phraseology and terminology employed herein are for the purpose of description and should not be regarded as limiting.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary diagram of a software automation platform for predicting results based on marketing data, according to some embodiments.

FIG. 2 is an exemplary diagram of a software administrative system for managing various account-level, user-level, and global settings and parameters within the software diagramed in FIG. 1.

FIG. 3 is an exemplary diagram of a computerized method for predicting results based on marketing data, according to some embodiments.

FIG. 4 is an exemplary diagram of a computerized method for predicting results based on marketing data, according to some embodiments.

FIG. 5 is an exemplary diagram of a computerized method for predicting results based on marketing data, according to some embodiments.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

The techniques described herein can be powered by a set of one or more algorithms, databases, 3^{rd}-party integrations, and technologies in order to create a marketing automation platform. The software is composed of numerous modules, each responsible for a specific part of the overall process. For ease of understanding certain of the modules are described in further detail in the following figures.

The modules work together in order to create a software system that can accept inputs from sources such as individual users, third-party APIs, and external databases, use predictive and machine learning processes (referred to herein generally as “Foresight”) to analyze data, and automatically take specific actions based of the analysis of that data.

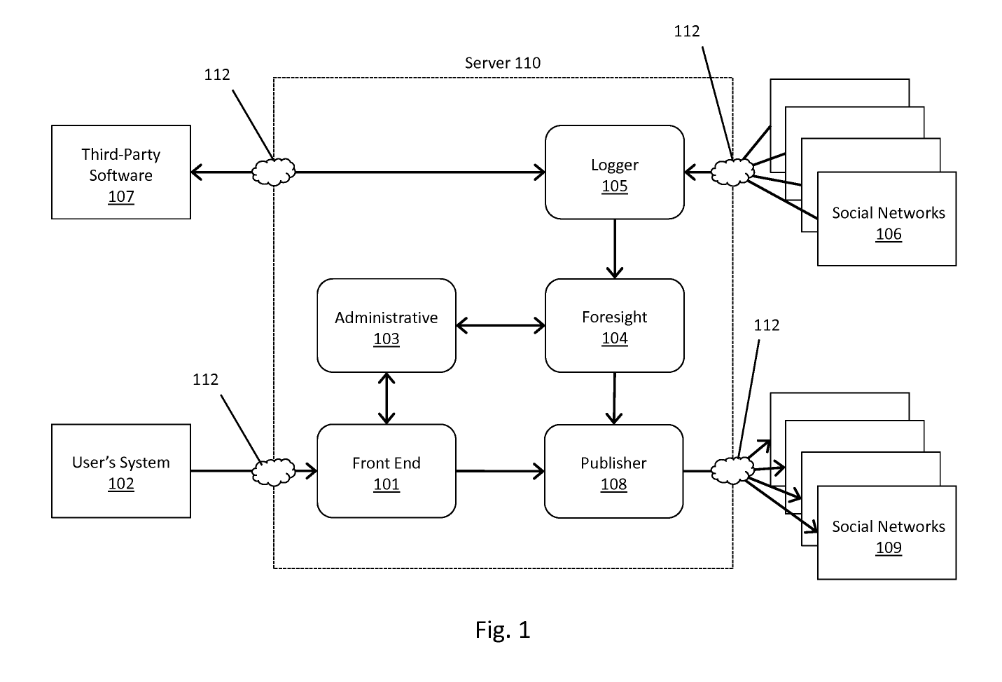

FIG. 1 is an exemplary diagram of an automation platform for predicting results based on social media data and automatically taking action based on those results. The system shown in FIG. 1 will be referred to herein generally as the “Cortex Software.” FIG. 1 shows in this embodiment the role of each module in the context of the overall software platform.

Element 101 is the Front End of the Cortex Software hosted on a cloud server. The front end serves as the primary user interface for the software. The front end may take many forms such as non-downloadable software accessed via a web browser, or a mobile application.

Element 102 represents the end-user devices which are used to access and interact with Element 101. Using a web browser, Element 101 can be accessed on computing devices such as desktop computers, laptop computers, and mobile devices. Element 101 can also be accessed through a dedicated mobile application on capable mobile devices. Additionally, aspects of Element 1 can be accessed via integration with third-party software such as mobile and web applications.

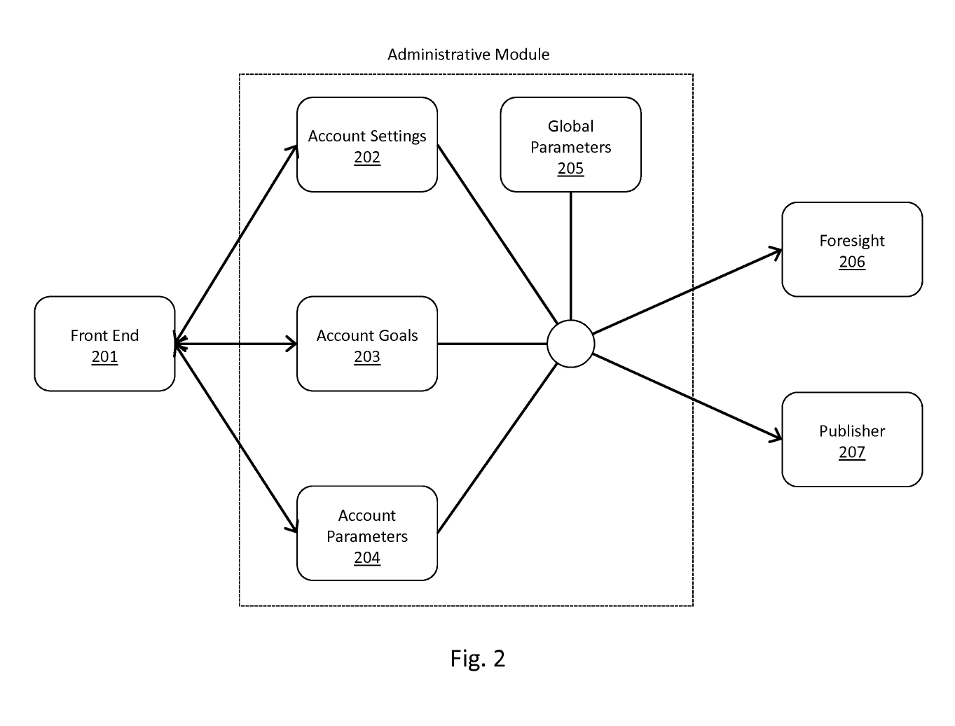

Element 103 is the Administrative Module of the Cortex Software hosted on a cloud server. This module handles numerous software processes such as, but not limited to, account management, account preferences/settings, and global parameters. The Administrative Module is further described in FIG. 2.

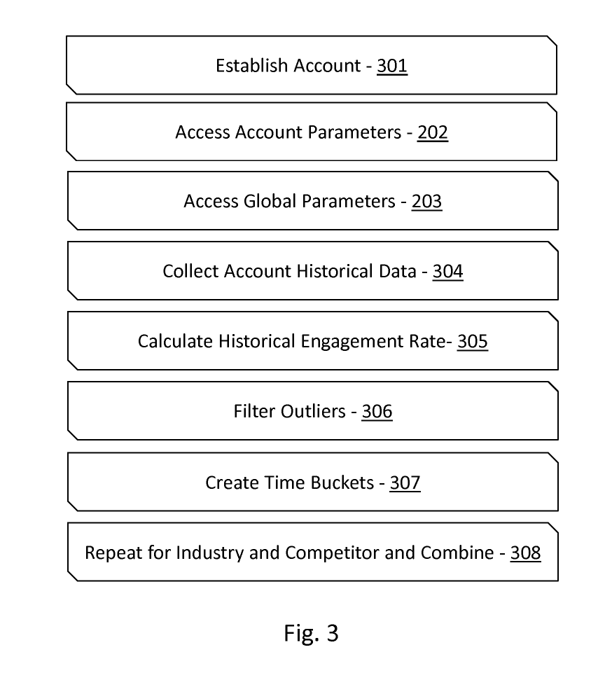

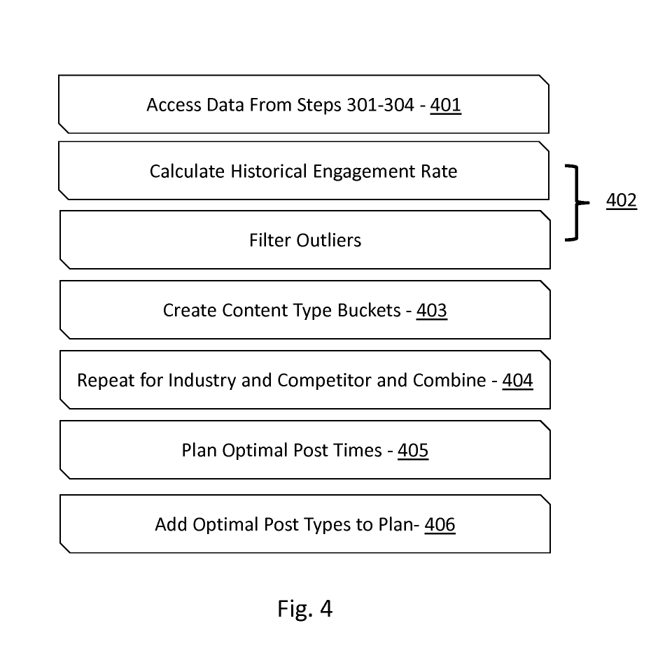

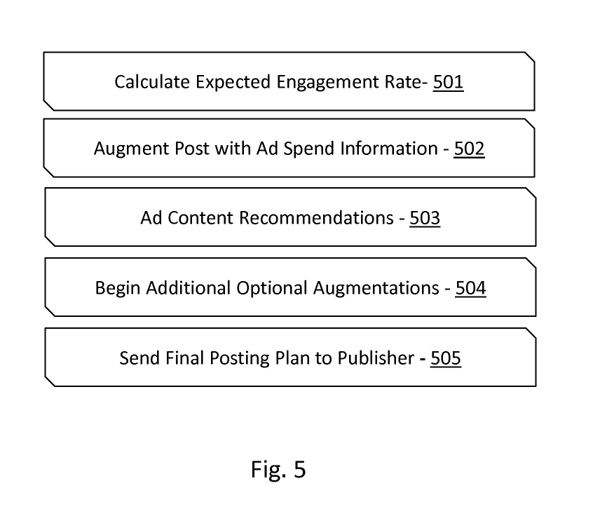

Element 104 is the Foresight Module, running as a service on a cloud server. In some manners, the Foresight Module may accept inputs from 103 and 105, in the form of either data or directives that may expand or restrict its functions. The output of the Foresight Module is then used by other modules of the Cortex Software such as displaying the output in various forms to the user via the Front End (102), and directing the Publisher (108). The Foresight Module is composed of a complex series of algorithms and processes that are explained in further detail later in this document, specifically in FIG. 3, FIG. 4, and FIG. 5. The various algorithms are referred to generally herein as “Foresight.”

Element 105 is the Logger Module, running as a service on a cloud server. In some manners, the Logger Module accesses social networks such as, but not limited to, Facebook, Twitter, Instagram, YouTube, and Pinterest (Element 106) for the purpose of gathering marketing data and storing that data in a Cortex Software database. The process used to gather this data may vary based on the social network, but techniques include API access and screen scraping. The exact elements of the data that is gathered are dependent on each social network and their changing API structures.

The data in the Logger Module is then used in various manners by the Foresight Module for purposes such as measuring and analyzing the historical performance of accounts, groups, and industries across various data dimensions and social networks. Additionally, the data in the Logger Module can be augmented, modified, and/or improved by integrations with third-party software and services (Element 107). An example of such augmentation would be connecting with a third party software to provide advanced semantic analysis on the raw text data gathered from marketing posts on social networks.

Element 108 is the Publishing Module, running as a server on a cloud server. In some manners, the Publishing Module receives information such as but not limited to, instructions, content, plans, and tasks from both the Foresight Module (104) and the Administrative Module (103). Based on this information the Publishing Module automatically distributes content and information to various social networks (109) through various methods. This content and information then appears on the social networks as if posted directly by the brand or organization of the User's Account.

The server 110 can contain modules that implement the system as described more fully in FIGS. 2-5 below. The server 110 can operate using an operating system (OS) software. In some embodiments, the OS software is based on a Linux software kernel and runs specific applications in the server such as monitoring tasks and providing protocol stacks. The OS software can allow server resources to be allocated separately for control and data paths. For example, certain packet accelerator cards and packet services cards can be dedicated to performing routing or security control functions, while other packet accelerator cards/packet services cards can be dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 110. A task can be a software process that performs a specific function related to system control or session processing. Three types of tasks operate within the server 110 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that run on the server 110 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem works in conjunction with the recovery control task subsystem to maintain the operational state of the server 110 by monitoring the various software and hardware components of the server 110. The recovery control task subsystem can be responsible for executing a recovery action for failures that occur in the server 110 and receives recovery actions from the high availability task subsystem. Processing tasks can be distributed into multiple instances running in parallel so that if an unrecoverable software fault occurs, the entire processing capabilities for that task are not lost. User session processes can be sub-grouped into collections of sessions so that if a problem is encountered in one sub-group users in another sub-group will not be affected by that problem.

The shared configuration task subsystem can provide the server 110 with an ability to set, retrieve, and receive notification of server configuration parameter changes and is responsible for storing configuration data for the applications running within the server 110. The resource management subsystem can be responsible for assigning resources (e.g., processor and memory capabilities) to tasks and for monitoring the task's use of the resources.

The network 112 can be a local area network (LAN), a wide area network (WAN), the Internet, a cellular network, a satellite network, or another network that permits communication between user devices 102 and server 110. The network 112 can further include one, or any number, of the exemplary types of networks mentioned above operating as a stand-alone network or in cooperation with each other. The network 112 can utilize one or more protocols of one or more clients or servers to which they are communicatively coupled. The network 112 can translate to or from other protocols to one or more protocols of network devices. Although the network 112 is depicted as one network, it should be appreciated that in some embodiments, the network 112 can comprise a plurality of interconnected networks. Other various network types or configurations can also be provided.

FIG. 2 is an exemplary diagram of a software administrative system for managing various account-level, user-level, and global settings and parameters. These parameters are used by other modules of the Cortex Software.

Element 201 is front end of the Cortex Software, already described in FIG. 1. The front end is the primary interface by which users set, define, modify settings, and otherwise interact with the Administrative Module.

Element 202 is the Account Settings. The Account Settings are defined by the user at the time they first register for the Cortex Software but may be modified. Additionally, new settings may be added as the software evolves. Account Settings include, but are not limited to, number and identity of users, social networks connected to the account, time zone of users, billing details, and other elements of software administration generally known. These settings are used in various manners by other modules in the Cortex Software.

Element 203 is the Account Goals. Account Goals are initially defined by user at the time they first register for the Cortex Software but may be modified. These goals are the method by which the user instructs the Cortex Software against which marketing metric they wish the software to optimize. There are numerous potential optimization goals that can vary based on the user's needs and the changing nature of the social networks with which the Cortex Software interacts. For the purposes of illustration, and by no means a complete list, the following are some metrics against which an account may wish the Cortex software to optimize: engagement rate (defined as the total number of engagements received by a unit of marketing content divided by the possible reach of that content), reach (defined as the number of views received by a unit of marketing content), and link clicks (defined as the number of clicks on any hyperlinks contained in the unit of marketing content). The chosen goal metric set by the user informs in some manners the processes of the Foresight Module, further described herein.

Element 204 is the Account Parameters, which, in some manners, generally restrict the dimensions considered by the Foresight and/or restrict the range of outputs when and where appropriate. These restrictions allow Foresight to automatically create optimized marketing plans that are more tailored to the business needs and idiosyncrasies of the account. For the purposes of illustration, and by no means a complete list, the following are examples of parameters that can be set and modified by the user: which social networks the user desires the software to publish content to (e.g. Facebook, Twitter, and Instagram); distribution times that are disallowed (e.g. the user wishes to prevent the software from posting to marketing platforms between the hours of midnight EST and 6 am EST); distribution days that are disallowed (e.g. the user wishes to prevent the software from posting to marketing platforms on Sundays); content types that are disallowed (e.g. the user wishes to prevent the software from recommending a plan that involves the distribution of video content); requested distribution frequency (e.g. the user wishes to specify a frequency of content distribution other than what is optimally recommended by the software); available advertising budget (e.g. the user wishes to specify the total available advertising budget over a given period of time, allowing the software to design and optimized spending plan that conforms to the available budget); custom tagging of content themes (e.g. the user wishes to define a custom set of themes in order to allow the software to make thematic content recommendations based on the user's existing marketing plan.)

Element 205 is the Global Parameters. Like the Account Parameters (204), Global Parameters, in some manners, generally restrict the dimensions considered by the Foresight and/or restrict the range of outputs when and where appropriate. Unlike Account Parameters, however, the developers of the Cortex Software, not users, set Global Parameters. For instance, a global parameter may ensure that Foresight never recommends distributing two posts to the same social network within 3 hours of each other.

The preceding elements of FIG. 2 can then be used by the Foresight Module and the Publishing module as expressed in FIG. 1.

By way of an illustrative example of how all these parameters might be practically employed, we consider the case of Customer X. Customer X is a beverage company with a presence in many countries around the world. Upon signing up for the software, Customer X specifies that the goal of their marketing efforts is to maximize engagement on the social platforms Facebook, Twitter, and Instagram. Customer X also has a small marketing team, and only has the ability to produce 21 units of marketing content per week, so they manually set a distribution frequency that will compel the Foresight algorithms to create a plan requiring no more than 21 units of marketing content per week. Customer X has no timing or content limitations, but they input into the software that they have $4,000 per month to be spent on advertising and promoting their social media posts. Customer X also inputs the countries in which their products are available so that, where allowed by the specific social networks, marketing content is geo-targeted only to relevant countries. These parameters have thereby restricted and refined the analysis and output of the Foresight algorithm so that it is optimally relevant to Customer X's business needs and goals.

FIG. 3 is an exemplary computerized method for predicting results based on marketing data, according to some embodiments. The techniques can be used to, for example, create a predictive model of optimal marketing tactics such as optimal distribution frequency and timing based on an analysis of historical and real-time data sources. The process in FIG. 3 is generally referred to as Foresight I and is part of the overall set of algorithms and processes generally referred to as Foresight.

In step 301, Foresight establishes which account it is analyzing from the Administrative Module. An account must have at least one user, but may have more than one, and must be connected to at least one social profile. Accounts may contain different data, different industries, different competitor sets, and different account parameters. Foresight must establish the account in order to ensure use of correct data and input in future steps.

In step 302, Foresight gets the Account Parameters as set by the user(s) of that account from the Administrative Module. As described previously, Account Parameters are often used to restrict the dimensions considered by Foresight and/or restrict the range of outputs when and where appropriate.

In step 303, Foresight gets the Global Parameters from the Administrative Module. As mentioned previously, these are universal regulations meant to apply blanket restrictions to Foresight when and where appropriate.

In step 304, Foresight collects the historical data of an account for use in the following steps. During this step, Foresight pulls all post and engagement data from the Logger Module for the Account over a given time period (such as 6-months, though able to be changed) as well as the data for the account's competitive set and, where possible, the account's industry.

In step 305, Foresight begins to analyze this data for patterns of success as defined by the Account Goals defined by the user in Administrative Module for the purpose of predicting the optimal timing of the distribution of future marketing units. The sample equations used in this and all the following steps are some manners, but no means the only manners of analysis, used by the Cortex Software. For the purposes of this example, we assume the Account desires to optimize for maximum post engagement. In this step we first calculate the engagement rate for all historical post data over the specified timeframe using one or more equations to calculate an engagement rate for one or more social media outlets. For example, the engagement rate can be calculated using equation 1a for Facebook, Equation 1b for Twitter, Equation 1c for Pinterest and Equation 1d for Instagram. Similar techniques can be applied to other social networks that provide user interaction data.

$$\begin{matrix}( Facebook ) \\ {Eng}_{i} = \frac{( {likes}_{i} + {shares}_{i} + {comment}_{i} )}{{fans}_{i}} & Equation 1 a \\ ( Twitter ) \\ {Eng}_{i} = \frac{( {favorites}_{i} + {retweets}_{i} + {replies}_{i} )}{{followers}_{i }} & Equation 1 b \\ ( Pinterest ) \\ {Eng}_{i} = \frac{( {likes}_{i} + {respins}_{i} + {comments}_{i} )}{{followers}_{i}} & Equation 1 c \\ ( Instagram ) \\ {Eng}_{i} = \frac{( {likes}_{i} + {comments}_{i} )}{{followers}_{i}} & Equation 1 d\end{matrix}$$

In step 306, using Equation 2 and data from Equation 1, Foresight filters out any posts that are two standard deviations away from the mean engagement rate to account for promoted or exceptional posts. The filter is configured using Global Parameters and can be overwritten for each account.

Eng^{f}=(μ−ρ2<Engi<μ+σ2) Equation 2:

In step 307, Foresight creates hourly time “buckets.” There are 24 buckets for each day of the week totaling of 168 buckets for 7 days. Using Equation 3 and engagement data from Equation 2, Foresight calculates the average engagement for each time bucket. The number of buckets is configured using Global Parameters but can be overwritten for each account.

$${Buckets}_{t} = \frac{( {\sum }_{i = 0}^{n} {Eng}_{t , i}^{f} )}{card ( {Eng}_{t}^{f} )} \qquad Equation 3$$

In step 308, Foresight applies steps 305, 306, and 307 to the account's industry data set (if available) and competitor data set (if available), which were gathered in step 304. Foresight then combines the resulting findings using Equation 4 by weighting the relative importance of each the phases of analysis (e.g. account, competitors, and industry). The weights are configured as Global Parameter but can be overwritten for each account.

$${Buckets}_{t}^{f} = ( {W}_{historical} \times {Buckets}_{t} ) + ( {W}_{industry} \times {Buckets}_{t} ) + ( {W}_{competitors} \times {Buckets}_{t} ) \qquad Equation 4$$

FIG. 4 is an exemplary computerized method for predicting results based on marketing data, according to some embodiments. The techniques can be used to, for example, create a predictive model of optimal marketing tactics based on an analysis of historical and real-time data sources. The process in FIG. 4 is generally referred to as Foresight II and is part of the overall set of algorithms and processes generally referred to as Foresight.

In step 401, Foresight accesses the Account, Account Parameters, Global Parameters, and Historical Data generated in steps 301-304.

In step 402, as was done for finding optimal times to post in FIG. 3, Foresight calculates the engagement rate for the account's historical social media data using Equation 1 (shown in step 305) and applying the filtering using Equation 2 (show in step 306).

In step 403, Foresight applies a bucketing technique, creating buckets for each type of social media content (status, photo, video, etc.) using Equation 5.

$${Buckets}_{p t} = \frac{( {\sum }_{i = 0}^{n} {Eng}_{p t , i}^{f} )}{card ( {Eng}_{p t}^{f} )} \qquad Equation 5$$

In step 404, Foresight applies steps 402, and 403 to the account's industry data set (if available) and competitor data set (if available), which were gathered in step 304. Foresight then combines the resulting findings using Equation 6 by weighting the relative importance of each the phases of analysis (e.g. account, competitors, and industry). The weights are configured as Global Parameter but can be overwritten for each account.

$${Buckets}_{p t}^{f} = ( {W}_{historical} \times {Buckets}_{p t} ) + ( {W}_{industry} \times {Buckets}_{p t} ) + ( {W}_{competitors} \times {Buckets}_{p t} ) \qquad Equation 6$$

In step 405, Foresight selects the top n posts for result set of Equation 4, buckets with optimal post times in order to create week-long optimized posting schedule. The number of posts selected, n, depends on the average historical posting frequency of an account but can be overwritten by Account Parameters. The minimum amount of time between posts is also taken into consideration but can be overwritten for each account. Using Equation 7 we find a set of optimal post times for the next week, where dw denotes the day of the week.

Foresights_{dw,i=>0->n}=select(n,Buckets_{t∈dw}^{f}) Equation 7:

In step 406, Foresight augments the generated posts (from step 405) with the optimal post types, based on the result set from Equation 6. Foresight creates a post type distribution and the distribution is used to sample the post type for augmenting the posting schedule. Account Parameters such as content type restrictions are applied. Using Equation 8 we calculate the post type distribution and using Equation 9 we augment the generated posts with post type data.

$${PostDistribution}_{p t} = \frac{{Buckets}_{p t}^{f}}{{\sum }_{p t = 0}^{n} {Buckets}_{p t}^{f}} \qquad Equation 8$$

Foresightsᵢ^{f}=augment(Foresightsᵢ,sample(PostDistribution)) Equation 9:

FIG. 5 is an exemplary computerized method for creating a predictive model for distribution of marketing materials based on marketing data, according to some embodiments. The techniques can be used to, for example, create a predictive model of optimal marketing tactics such advertising spend and subjective content recommendations based on an analysis of historical and real-time data sources. Account Parameters such as maximum posts per day, and content type filters are taken into consideration. The process in FIG. 5 is generally referred to as Foresight III and is part of the overall set of algorithms and processes generally referred to as Foresight

In Step 501, Foresight begins a series of optional augmentations to the optimized week-long marketing plan created through the preceding steps. There are numerous optional steps that can be added into the Cortex Software as this point. This step and the following steps in FIG. 5 are examples. First Foresight augments the posting plan completed in step 406 with an optimized advertising plan for given social network account. Account Parameters such as total budget and maximum individual spend are taken into consideration. This strategy is applied to social networks that allow for advertising spends and boosting of social media content. With Equation 10, using engagement values found by Equation 4 and Equation 6, Foresight calculates the expected engagement of each scheduled post from Equation 9.

Foresightsᵢ^{fs}=(Wₚ_{^{t}}×Bucketsₚₜ^{f})+(Wₜ×Bucketsₜ^{f}) Equation 10:

In step 502, using Equation 11, and results from Equation 10, Foresight selects the top n scheduled posts based on expected engagement. Using Equation 12, those posts are augmented with ad spend data. The budget and weekly ad spend are Account Parameters that are defined for each account.

$$\begin{matrix} {ApSpend}_{i} = select ( n , {Foresights}_{i}^{fs} ) & Equation 11 \\ {Foresights}_{i}^{fsb} = augment ( {Foresights}_{i}^{fs} , ( \frac{{AdSpend}_{i}}{{\sum }_{i = 0}^{n} {AdSpend}_{i}} ) ) \times budget & Equation 12\end{matrix}$$

In step 503, Foresight augments the posting plan with content and/or thematic recommendations for each post on a given social network. The content recommendation can be in the form of recommended hyperlinks, recommended images and/or image types, recommended videos and/or video types, and recommended textual content. Using 3rd-party APIs and account history we augment each post in the posting plan with a number of content suggestions which the user can select. Using Equation 13 for each resulting post from Equation 12, we select n content themes for a given post type. For example; if the post type is photo we recommend n photo themes based on top historical photo themes ranked using Equation 1. Examples of photo themes are photos with certain colors, photos with certain objects in them, photos with recognizable human faces, etc.

Foresightsᵢ^{fsbr}=augment(Foresightsᵢ^{fsb},select(n,RecommendedContentᵢ)) Equation 13:

Step 504 represents the position in the process of future optional augmentations to the posting plan. Based on availability of data and new partners, various new methods of augmenting and improving the posting pan may be generated.

In step 505, the completed posting plan is sent to the Publishing Module, as diagramed in FIG. 1.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A computerized method for optimizing marketing strategy, comprising:
receiving, by a computing device, from a user device a request to analyze marketing data associated with a marketer, wherein the received request further includes goals of the analysis;
collecting, by a logging module being executed by the computing device, marketing data associated with the marketer from at least one third party web server;
analyzing, by the computing device, the marketing data for patterns associated with a desired outcome;
generating, by the computing device, an optimal strategy for distribution of marketing elements across third party web applications;
automatically executing, by the computing device, the optimal strategy, wherein the executing includes periodically distributing marketing materials to third party web applications at defined intervals; and
sending, by the computing device, an indication of the optimal strategy to the user device.

2. The method of claim 1, wherein the analyzing the marketing data for patterns further comprises comparing times associated with subsets of the marketing data.

3. The method of claim 2, wherein the optimal strategy further includes generating an optimal daily distribution time for marketing materials.

4. The method of claim 1, wherein the third party web applications include at least one social network.

5. The method of claim 1, wherein the collected marketing data includes data associated with competitors of the marketer.

6. The method of claim 1, wherein the received request further includes a budget associated with advertising materials to be used with the generated optimal strategy.

7. The method of claim 4, wherein the periodically distributing marketing materials comprises automatically creating a post on the at least one social network.

8. A system for optimizing marketing strategy, comprising:
one or more processors communicatively coupled to a network; wherein the one or more processors are configured to:
receive, by a computing device, from a user device a request to analyze marketing data associated with a marketer, wherein the received request further includes goals of the analysis;
collect, by a logging module being executed by the computing device, marketing data associated with the marketer from at least one third party web server;
analyze, by the computing device, the marketing data for patterns associated with a desired outcome;
generate, by the computing device, an optimal strategy for distribution of marketing elements across third party web applications;
automatically execute, by the computing device, the optimal strategy, wherein the executing includes periodically distributing marketing materials to third party web applications at defined intervals; and
send, by the computing device, an indication of the optimal strategy to the user device.

9. The system of claim 8, wherein the analyzing the marketing data for patterns further comprises comparing times associated with subsets of the marketing data.

10. The system of claim 9, wherein the optimal strategy further includes generating an optimal daily distribution time for marketing materials.

11. The system of claim 8, wherein the third party web applications include at least one social network.

12. The system of claim 8, wherein the collected marketing data includes data associated with competitors of the marketer.

13. The system of claim 8, wherein the received request further includes a budget associated with advertising materials to be used with the generated optimal strategy.

14. The system of claim 11, wherein the periodically distributing marketing materials comprises automatically creating a post on the at least one social network.

15. An article of manufacture for optimizing marketing strategy, the article of manufacture comprising:
at least one non-transitory processor readable storage medium; and
instructions stored on the at least one medium;
wherein the instructions are configured to be readable from the at least one medium by at least one processor and thereby cause the at least one processor to operate so as to:
receive, by a computing device, from a user device a request to analyze marketing data associated with a marketer, wherein the received request further includes goals of the analysis;
collect, by a logging module being executed by the computing device, marketing data associated with the marketer from at least one third party web server;
analyze, by the computing device, the marketing data for patterns associated with a desired outcome;
generate, by the computing device, an optimal strategy for distribution of marketing elements across third party web applications;
automatically execute, by the computing device, the optimal strategy, wherein the executing includes periodically distributing marketing materials to third party web applications at defined intervals; and
send, by the computing device, an indication of the optimal strategy to the user device.

16. The article of manufacture of claim 15, wherein the analyzing the marketing data for patterns further comprises comparing times associated with subsets of the marketing data.

17. The article of manufacture of claim 16, wherein the optimal strategy further includes generating an optimal daily distribution time for marketing materials.

18. The article of manufacture of claim 15, wherein the third party web applications include at least one social network.

19. The article of manufacture of claim 15, wherein the collected marketing data includes data associated with competitors of the marketer.

20. The article of manufacture of claim 15, wherein the received request further includes a budget associated with advertising materials to be used with the generated optimal strategy.
